(19) United States
(12) Patent Application Publication
(10) Pub. No.: US 2011/0097689 A1
(43) Pub. Date: Apr. 28, 2011

(54) Introduced-In Enhancement in Morse Cone Mini Pillar

(76) Inventor: Geninho Thome, Curitiba (BR)

(21) Appl. No.: 12/999,221

(22) PCT Filed: Jun. 16, 2009
(86) PCT No.: PCT/BR09/00161

§ 371 Date: Jan. 4, 2011

(30) Foreign Application Priority Data
Jun. 17, 2008 (BR) MU8800606-9

(51) Int. Cl. A61C 8/00; A61C 13/225

(52) U.S. Cl. 433/174

(57) ABSTRACT

The subject utility model patent application concerns with an innovator Morse cone mini pillar provided with a peculiar connection since it has a Morse cone technology that enables a connection with a dental implant conic cavity.

The subject utility model patent application concerns with an innovator conic mini pillar, the subject matter of which is specifically a conic mini pillar provided with a peculiar connection since it has a morse cone technology, i.e., it comprises an outer geometry morse cone in its lower part, thus enabling a connection with the dental implant conic cavity of a morse cone system by the use of this kind of connection (morse cone) to a conic mini pillar. The fastening thread can have a single body with the mini pillar or be in two individual pieces, mini pillar body and through-pass screw. Such aspects provide improvements in the kind of connection between the implant and the prosthesis.

Such conic mini pillar is used as an intermediate between the intraorally placed morse cone implant and the planned prosthesis according to each case, components diameters and tolerance indication being respected aiming at aesthetics and function.

The morse cone mini pillar is machined from ASTM F136 biocompatible titanium available as a sterile form for single use.

The morse cone mini pillar is packed in blisters packages (surgical grade film and paper) available as single units on the market. The morse cone mini pillars will be available with varying height extents from 1.5 to 2.5 millimeters (mm).

The respective conic mini pillar which is the object of subject utility model patent is characterized by having an outer geometry in its lower part thus enabling a connection with the dental implant conic cavity of a morse cone system; the fastening thread can have a single body with the mini pillar or be in two individual pieces, mini pillar body and through-pass screw, free-slot closure of mini pillar/implant surfaces, and, since it has other aspects allowing more efficient implant and prosthetic component contact, by these and other reasons the subject enhancement provides larger efficacy and surgical process quality referring to the conic mini pillar, thus figuring as a new product on the congener market and bringing several benefits in its use.

In comparing with conic mini pillar and traditional mini pillar, there can be observed that:
Connection type: The morse cone mini pillar has a morse cone so as to be connected on the implant, whereas that traditional has a smooth hexagon or diameter so as to be connected on the implant.
Composition: The morse cone mini pillar has a single body uniting the mini pillar and the thread in a single piece, whereas the ordinary mini pillar is composed of two pieces, one piece being the mini pillar and the other the cross fastening screw.

In this way, the conic mini pillar, the subject patent objet, which has a morse cone system so as to be connected on the implant and is composed of a single piece that is composed of the mini pillar together with the fastening screw, generates a better quality of surgical process and a better connection between the implant and the prosthesis.

Aiming at a better comprehension of the dispositions concerning with the subject enhancement, there follows drawings that will be the object of references together with the detailed specification that follows, wherein:

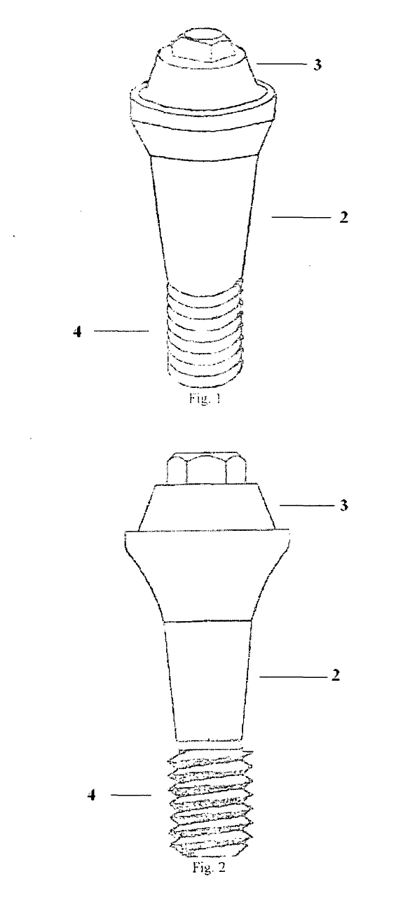

FIG. 1 illustrates in perspective view the conic mini pillar (3) provided with a morse cone (2) and the thread (4);

FIG. 2 illustrates in front view conic mini pillar (3) provided with a morse cone (2) and the thread (4);

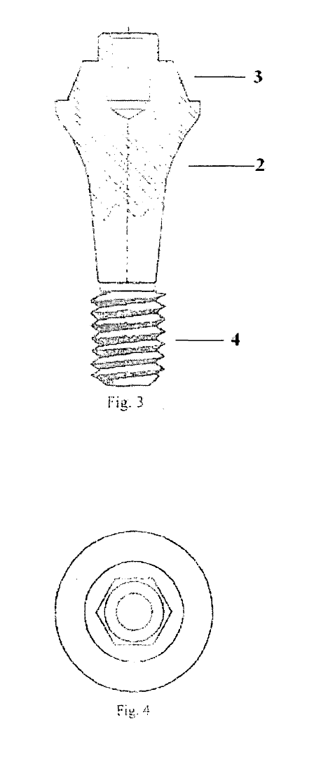

FIG. 3 illustrates in front view the conic mini pillar (3), however in cut, for the morse cone system (2) be demonstrated; and,

FIG. 4 demonstrates in top view the conic mini pillar (3).

It suits enlighten that hereby presented model is illustrated in a demonstrative but not restrictive way, which conception can vary as for measures, said enhancement may also undergo diversification as its extents and including materials, without reasonably deviating from the main inventive objet scope which protection is claimed.

In this way, the utility model patent concerns with a conic mini pillar (3) provided with a morse cone (2) and thread (4) that generates a better engage between the morse cone implant and the prosthesis thus providing better efficacy and quality to the surgical process.

The above descriptions are not by way of limitation to the subject utility model scope and other uses may become evident from those presently described. Accordingly other concepts including variations of or modifications on the subject utility model will become obvious from that presently described; however such variations and modifications are included in the subject utility model scope.

1. Introduced-in enhancement in morse cone mini pillar, characterized in that said conic mini pillar (3) comprises a morse cone (2) with an outer geometry morse cone in its lower part, thus enabling a connection with the dental implant conic cavity and a thread (4) that can be of a single body with the conic mini pillar (3) or be in two individual pieces, mini pillar body and through-pass screw.
